(19) United States
(12) Patent Application Publication
(10) Pub. No.: US 2004/0106815 A1
(43) Pub. Date: Jun. 3, 2004

(54) Selective synthesis of organophosphites

(76) Inventor: Joachim C. Ritter, Wilmington, DE (US)

Correspondence Address: E I DU PONT DE NEMOURS AND COMPANY, LEGAL PATENT RECORDS CENTER, BARLEY MILL PLAZA 25/1128, 4417 LANCASTER PIKE, WILMINGTON, DE, 19805, US

(21) Appl. No.: 10/454,043

(22) Filed: Jun. 4, 2003

Related U.S. Application Data
(60) Provisional application No. 60/430,426, filed on Dec. 2, 2002.

(51) Int. Cl. C07F 9/02

(52) U.S. Cl. 558/128

(57) ABSTRACT

Disclosed herein is a process for the selective synthesis of triorganophosphites intermediates, including chloridites and dichloridites, from PX₃ (X=Cl, Br or I), alcoholos and triorganoamines where alcohol and triorganoamine are added either (a) separately and concurrently, or (b) alternating equimolar portions of amine and alcohol.

### CROSS-REFERENCE TO RELATED APPLICATIONS

This application claims the benefit of priority to provisional application No. 60/430,426 filed on Dec. 2, 2002, in the name of Joachim Ritter.

### FIELD OF THE INVENTION

This application relates to a process for the selective synthesis of intermediates, including chloridites and dichloridites, for the synthesis of triorganophosphites.

### BACKGROUND OF THE INVENTION

Organophosphites of the general structure (R¹⁰)P(OR²)(OR³) are used in a number of commercially important applications including their use as antioxidants, stabilizers, anti-wear additives and as ligands for various catalytic processes. Generally organophosphites are produced from PX₃ (X=Cl, Br, I) and the corresponding alcohols. This reaction occurs stepwise by displacement of X with OR and results in the formation of the corresponding phosphite esters (R¹⁰)P(OR²)(OR³) and acid HX. The acid can be removed by means of physical separation or by means of acid base reaction using organic or inorganic bases as additives.

Several methods for making organophosphites are described in Houben-Weyl, Bd. XXII/2 pages 12-17, G. Thieme Verlag, Stuttgart 1964, and supplement E1, pages 413-421 Stuttgart, N.Y. 1982, are known for the production of phosphites using readily available PCl₃ and the corresponding alcohols. However, the selectivity of the displacement of Cl by the alcohol to give the corresponding phosphorous dichloridite (R¹⁰)P(Cl₂) and chloridite (R¹⁰)P(OR²)(Cl), respectively, is generally low. This limits the formation of any specific phosphite of the general structure (R¹⁰)P(OR²)(OR³) to low yields, except when R¹, R² and R³ are the same. Though for some applications this low selectivity is acceptable, for others, selectivity to a specific structure with different R groups is highly desirable.

In Houben-Weyl, Bd. XXII/2 pages 12-17, G. Thieme Verlag, Stuttgart 1964, it is summarized that a large excess of PCl₃ is needed to preferably form a dichloridite from aliphatic or aromatic alcohols suppressing the second displacement reaction and distillation of the crude dichloridite is obligatory to separate the excess PCl₃. Similarly the formation of chloridite from dichloridite and alcohol shows low selectivity, and extensive purification by distillation is needed.

WO 01/32666 describes a high yield process for the synthesis of PCl(O-m-tolyl)₂ however, due to low selectivities, a time consuming process consisting of a) distillation to separate from by-products dichloridite PCl₂(O-m-tolyl) and triarylphosphite P(O-m-tolyl)₃ and b) subsequent recycle of the by-products is needed.

From WO96/22968 it is known that higher selectivity for the synthesis of chloridites and dichloridites can be achieved by a stepwise protective group approach, however this reaction sequence requires two additional reaction steps for each RO group introduced adding considerable cost to the overall process.

Selectivity to form chloridite and/or dichloridite from PX₃ and ROH are generally higher if organic tertiary amines are used in equimolar amounts. For example U.S. Pat. No. 4,120,917 describes the use of tertiary amines as acid scavengers for the production of alkylphosphorodichloridites. A mixture of amine and alcohol is added to an excess of PCl₃ in an organic solvent to produce the corresponding dichloridites in moderate yields. However, a five-fold excess of PCl₃ is needed to suppress the formation of chloridite. In addition, subsequent filtration of the ammonium salt is required and PCl₃ has to be removed by distillation before a mixed phosphite can be produced. Both filtration and PCl₃ distillation are significant cost factors.

U.S. Pat. No. 6,069,267 describes a process for the selective synthesis of organodiphosphite compounds using PCl₃ and aryl alcohols however the procedure only gives acceptable yields with very bulky ortho-substituted phenols as alcohols and does not provide high yields for a general range of mixed triarylphosphites within a commercially favorable temperature range.

The selective commercial production of mixed organophosphites (R¹⁰)P(OR²)(OR³) requires a method by which the displacement of X by the alcohol in PX₃ and ROPX₂ occurs with high selectivity under commercially feasible conditions. It would be desirable to have a high yield highly selective process for the production of dichloridites, chloridites and mixed phosphites at a cost that is commercially feasible. This invention described herein is such a process.

### SUMMARY OF THE INVENTION

Disclosed herein is a process for the selective production of R¹OPX₂; (R¹⁰)(R² O)PX and (R¹⁰)(R² O)P(O R³) wherein X=Cl, Br, I, and R¹, R², and R³ are the same or different C1 to C18 aryl or alkyl radicals, comprising:

(i) contacting PX₃ in the presence of an aprotic solvent with an alcohol R¹OH and a triorganoamine, wherein the amine and the alcohol are added either (a) separately and concurrently, or as (b) alternating equimolar portions of amine and alcohol, to produce R¹OPX₂;

(ii) optionally contacting the reaction product of (i) with an alcohol R²OH and a triorganoamine, wherein the amine and the alcohol are added either (a) separately and concurrently, or as (b) alternating equimolar portions of amine and alcohol, to produce (R¹⁰)(R²O)PX;

(iii) optionally contacting the reaction product of (i or ii) with an alcohol R³OH and a triorganoamine, to produce (R¹O)(R²O)P(OR³).

### DETAILED DESCRIPTION

The present invention describes a simple process for the selective synthesis of phosphorochloridites (R¹O)(R²O)PX, product (1) wherein X is Cl, Br or I, and wherein R¹ is C1 to C18 aryl or alkyl radical and phosphorodichloridites (R¹O)PX₂, product (2), and subsequent transformations of (1) and (2) into triorganophosphites (R¹O)P(OR²)(OR³), product (3). The process involves the addition of a trialkylamine and an alcohol ROH to PX₃ or (R¹O)PX₂ in a separate but concurrent fashion. It is critical to add the amine and the alcohol separately in such a way that both materials exhibit low concentration within the reaction vessel where the formation of the products occurs. This can be achieved by using separate feed lines for amine and alcohol attached to the reaction vessel at different locations. Alternatively, addition of the alcohol and the amine are carried out by alternating equimolar portions of triorganoamine and alcohol. In a preferred version of this addition mode at least 2 alternating additions are employed. Most preferred is the separate but concurrent addition mode.

During the addition, good agitation using methods known by those skilled in the art is important to provide sufficient heat removal and avoid areas of highly concentrated amine or alcohol. Furthermore, it is preferred to add the amine and the alcohol in such a fashion that the amount of alcohol added does not exceed significantly the molar equivalent amount of amine added at any given time in the procedure. This method is especially useful for the production of mixed compounds (1) and (3). At any given time of the concurrent alcohol and amine addition, the alcohol feed may be changed to a different alcohol. Mixed phosphorochloridites, (R¹O)(R²O)PX (1), can be synthesized in high selectivity by first adding one equivalent of alcohol R¹OH and amine, separately and concurrently, followed by one equivalent of alcohol R²OH and amine.

The triorganoamine used should be anhydrous and is selected from the group consisting of aliphatic, aromatic and hetero aromatic amines, or combinations thereof. The triorganoamine used may be substituted or unsubstituted. It is important however that the corresponding ammonium salt exhibits a low solubility in the reaction medium to avoid undesired rearrangement reactions of the phosphite products. Preferred amines are amines selected from the group consisting trialkylamines wherein the alkyl groups are linear, branched or cyclic, have 1 to 12 carbon atoms and may be linked together. More preferred amines are chosen from the group of trimethylamine, dimethylethylamine, diethylmethylamine, triethylamine, dimethylpropylamine and dimethylisopropylamine.

Aprotic solvents are suitable provided they do not react with PX₃, amine, alcohol and ammonium salts. The solvent should not have the ability to dissolve the ammonium salt produced during the reaction since the acidity associated with dissociated ammonium salts can cause undesired rearrangement reactions. Furthermore, a solvent with a melting point below the desired reaction temperature is preferred. Preferred solvents are selected from the group of organic aprotic solvents or mixtures thereof. More preferred are solvents or solvent mixtures selected from the group of aliphatic and aromatic solvents. Most preferred solvents or solvent mixtures are aromatic solvents selected from the group consisting of toluene, xylenes, tetraline and ethylbenzene.

The rate of addition of amine and alcohol is generally limited by the mixing and cooling capabilities of the equipment. Practical addition times range from 15 minutes to 12 hours. A preferred range is 1 to 6 hours.

Reagent and product concentrations are generally limited by the ability to effectively mix the resulting slurry of trialkylamine-HX. The concentrations of the phosphorous species, the amine and the alcohol can be independently chosen only limited by density and solubility as long as the above and below mentioned process conditions described herein are maintained. Reagents may be fed neat or diluted with solvent. A preferred concentration range for the amine and alcohol feed is 1-4 mol/l in feed solutions. The final concentration of phosphorus-containing product in the reactor may range from about 1% to 35%. The preferred concentration of the phosphorous containing product in the reactor ranges from 7% to 25% by weight.

It is important to carry out the present process in the absence of water. Hence, it is necessary to ensure that the solvents, amine and alcohol are dry and to conduct the process under an inert gas atmosphere.

Suitable PX₃ compounds are those where X is capable of exchange reactions with alcohols in the presence of a triorganoamine to form a P—OR bond and a salt of HX-triorganoamine. Preferred groups for X are Cl, Br, I. Most preferred is Cl.

In principle all alcohols capable of reacting with PX₃ in the presence of a base are suitable substrates for the present invention. Aromatic as well as aliphatic alcohols show significantly higher selectivities in the displacement reaction with PX₃ and (R¹O)PX₂ if the above mentioned process is applied. Non-exclusive examples for suitable alcohols are primary, secondary and tertiary aliphatic alcohols including diols and polyols. Further nonexclusive examples include aromatic alcohols, diols and polyols from the group of substituted and unsubstituted phenols, naphthols, hydroxyphenanthrenes and hydroxyanthracenes, hydroxy substituted heteroaromatic compounds.

Maintaining a reaction temperature below 20° C. throughout the entire reaction vessel and addition period of the alcohol and the amine is an important feature of this invention. The preferred reaction temperature for a given displacement of X in PX₃ depends on the steric and electronic nature of the alcohol ROH. Whereas o-isopropyl substituted phenols give good selectivity to the corresponding phosphorodichloridites and chloridites even at +15° C., less sterically demanding alcohols such as phenol and cresols are added preferably at temperatures below 5° C. For most alcohols, lower temperatures are generally preferred however it is not always necessary to choose a temperature at about or below −5° C. to achieve the desired selectivity. If the reactivity of the alcohol is low a reaction temperature high enough to provide a reaction rate equal or faster than the addition rate is preferred. Since under commercial operation the temperature range achievable is subject to limits of the equipment available temperatures above −25° C. are generally preferred. A preferred temperature range for this process is −10° C. to +10° C.

The reaction is relatively insensitive to pressure and is limited only by practical considerations. For practical reasons, preferred reaction pressure ranges from 10 psia (69 kPa) to 50 psia (345 kPa).

The products (1) and (2) formed by above described process can be transformed conveniently in the same or a separate vessel to the corresponding phosphites (R¹⁰)P(OR²)(OR³) (3), thiophosphites (R¹O)P(OR²)(SR⁴), (R¹O)P(SR⁴)(SR⁵), amidites (R¹O)P(OR²)(NR⁶R⁷), (R¹O)P(NR⁶R⁷)(NR⁸R⁹) by displacing the remaining phosphorous ligands X with OR, NR⁶R⁷ and SR⁴ groups, respectively, or hydrolyzed to the compound (R¹O)(R²O)POH. For (R¹O)P(OR²)(OR³), or an ABCP type, this can be achieved by adding about one equivalent of amine followed by one equivalent alcohol HOR³ to product (1). For (R¹⁰)P(OR²)₂, or an A2BP type, this can be achieved by adding about two equivalents of amine followed by two equivalents alcohol HOR² to product (2). In contrast to the formation of (1) and (2), for transformation to (3) and derivatives described above, the alcohols and amines may be fed as a mixture, if so desired. Likewise thiophosphites (R¹O)P(OR²)(SR⁴), (R¹O)P(SR⁴)(SR⁵), amidites (R¹O)P(OR²)(NR⁶R⁷), (R¹O)P(NR⁶R⁷)(NR⁸R⁹) can be produced from product (1) or (2) and secondary amines and thiols, respectively.

The process described herein can be carried out as a continuous process whereby the amine and the alcohol are added concurrently but separately into a continuous type reactor, such as a continuous flow stirred tank reactor (CSTR). Simultaneously PX₃ is added separately or together with the amine, and the amine and the alcohol are fed separately and concurrently. This embodiment of the present invention has the advantage of smaller reaction volumes with improved mixing and heat transfer. In a more preferred variation of a continuous process a series of 2-10 CSTR's are used whereby the PX₃ is fed into the first reactor only and the amine and the alcohol are fed separately and concurrently in equimolar portions into each reactor. In the most preferred version of a continuous reactor a plug-flow reactor is employed where PX₃ is fed into an entry port at the beginning of the plug-flow reactor and the amine and the alcohol are added concurrently but separately in equimolar portions into multiple entry ports along the length of the plug-flow reactor.

### EXAMPLES

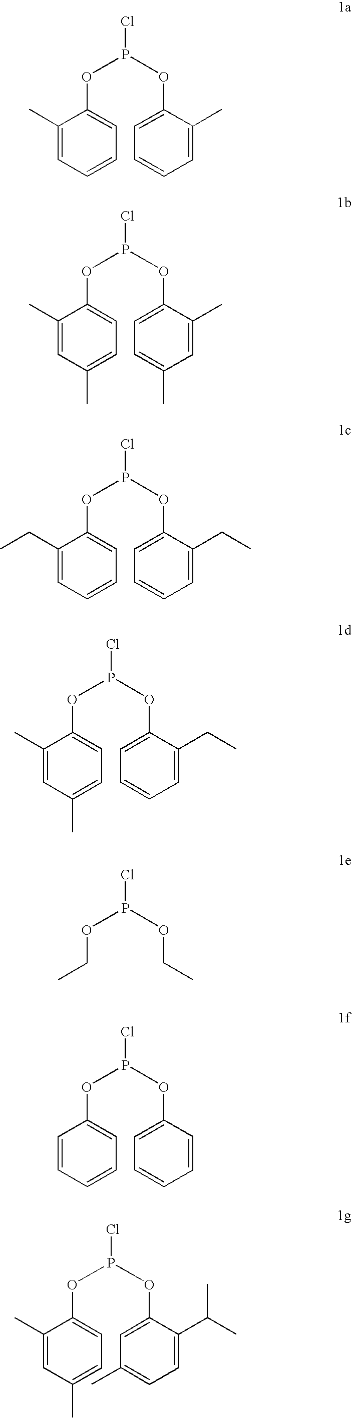

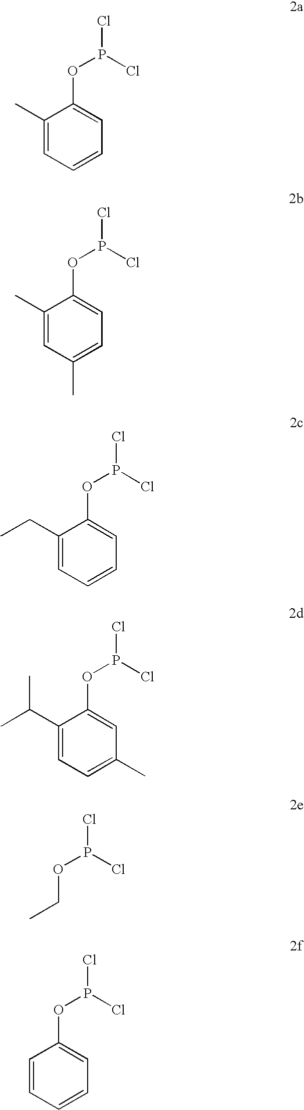

Examples 1, 9, 10, and 16 show that a chloridite and dichloridite derived from an aromatic alcohol (ArOH) with little steric hindrance can be produced in high selectivity. All ³¹P NMR chemical shifts δ (75 MHz) are given in ppm in reference to triphenylphosphineoxide (δ 25.6). Unless otherwise noted all ³¹P NMR samples were prepared by mixing 0.4 ml of the reaction volume with 0.8 ml of 0.1 molar triphenylphosphineoxide in C6D6. All reactions and sampling procedures were performed under the exclusion of air and moisture.

### Example 1

### Synthesis of Phosphorochloridite 1a and Phosphorodichloridite 2a

In a temperature controlled 250 ml baffled flask charged with 50 ml of 1.0 molar PCl₃ in toluene, a solution of 25 ml 2.0 molar triethylamine in toluene, and a solution of 25 ml 2.0 molar o-cresol in toluene were added separately and concurrently under vigorous stirring via a dual syringe pump over a period of 90 min. During the addition period the reaction temperature was maintained between −5° C. The ³¹P NMR analysis showed clean transformation to the corresponding dichloridite 2a (δ 182.7) in 97% selectivity. A second 25 ml of each 2.0 molar triethylamine solution in toluene and 2.0 molar o-cresol solution in toluene were added separately and concurrently via a dual syringe pump over a period of 90 min. The ³¹P NMR analysis showed clean transformation to the corresponding chloridite 1a (δ 161.9) in 91% overall selectivity.

### Examples 2-5

demonstrate the temperature effect on the yield of 1a and 2a. These examples were carried out under the same conditions as example 1 but at different temperatures. Results as derived from ³¹P NMR analysis are shown in Table 1

TABLE 1

| | | Equivalents | | | | |
|---|---|---|---|---|---|---|
| | Temp | ArOH and | | | % | % |
| Example | (° C.) | NEt₃ added | % 1a | % 2a | PCl₃ | (o-tolyl-O)₃P |
| 2 | −5 | 1.0 | 3 | 97 | 0 | 0 |
| | | 2.0 | 91 | 4 | 0 | 5 |
| 3 | +5 | 1.0 | 4 | 94 | 2 | 0 |
| | | 2.0 | 91 | 3 | 0 | 6 |
| 4 | −15 | 1.0 | 2 | 97 | 1 | 0 |
| | | 2.0 | 92 | 3 | 0 | 5 |
| 5 | +15 | 1.0 | 4 | 88 | 8 | 0 |
| | | 2.0 | 90 | 5 | 0 | 5 |

### Examples 6-8

demonstrate the effect of feed rates on the yield of 1a and 2a. These examples were carried out under the same conditions as example 1 but at different feed rates. Results as derived from ³¹P NMR analysis are shown in Table 2.

TABLE 2

| | | Equivalents | | | | |
|---|---|---|---|---|---|---|
| | Feed rate | ArOH and | | | % | % |
| Example | equiv / h | NEt₃ added | % 1a | % 2a | PCl₃ | (o-tolyl-O)₃P |
| 6 | 0.67 | 1.0 | 3 | 97 | 0 | 0 |
| | | 2.0 | 91 | 4 | 0 | 5 |
| 7 | 1.20 | 1.0 | 4 | 93 | 3 | 0 |
| | | 2.0 | 94 | 0 | 0 | 6 |
| 8 | 2.4 | 1.0 | 2 | 92 | 6 | 0 |
| | | 2.0 | 88 | 3 | 0 | 9 |

### Example 9

### Synthesis of Phosphorochloridite 1b and Phosphorodichloridite 2b

In a temperature controlled 250 ml baffled flask charged with 50 ml of 1.0 molar PCl₃ in toluene, a solution of 25 ml 2.0 molar triethylamine in toluene, and a solution of 25 ml 2.0 molar 2,4-xylenol in toluene were added separately and concurrently under vigorous stirring via a dual syringe pump over a period of 90 min. During the addition period the reaction temperature was maintained at −5° C. The ³¹P NMR analysis exhibited clean transformation to the corresponding dichloridite 2b (δ 183.0) in 98% selectivity. Another 26.0 ml of each 2.0 molar triethylamine solution in toluene and 2.0 molar 2,4-xylenol solution in toluene were added separately and concurrently via a dual syringe pump over a period of 90 min. The ³¹P NMR analysis exhibited clean transformation to the corresponding chloridite 1b (δ 162.3) in 93% overall selectivity.

### Example 10

### Synthesis of Phosphorochloridite 1c and Phosphorodichloridite 2c

In a temperature controlled 250 ml baffled flask charged with 50 ml of 1.0 molar PCl₃ in toluene, a solution of 26 ml 2.0 molar triethylamine in toluene, and a solution of 26 ml 2.0 molar o-ethylphenol in toluene were added separately and concurrently under vigorous stirring via a dual syringe pump over a period of 90 min. During the addition period the reaction temperature was maintained at −5° deg. C. The ³¹P NMR analysis exhibited clean transformation to the corresponding dichloridite 2c (δ 183.2) in 96% selectivity. Another 24.0 ml of each 2.0 molar triethylamine solution in toluene and 2.0 molar o-ethylphenol solution in toluene were added separately and concurrently via a dual syringe pump over a period of 90 min. The ³¹P NMR analysis exhibited clean transformation to the corresponding chloridite 1c (δ 161.5) in 93% overall selectivity

### Example 11

This example shows that the selectivity of the displacement reaction of chloride by phenolate in PCl₃ during the synthesis of dichloridite 2c decreases significantly if the amount of alcohol added exceeds the amount of amine added during the addition procedure.

In a temperature controlled 250 ml baffled flask charged with 50 ml of 1.0 molar PCl₃ in toluene, a solution of 25 ml 2.0 molar triethylamine in toluene, and a solution of 25 ml 2.5 molar o-ethylphenol in toluene were added separately and concurrently under vigorous stirring via a dual syringe pump over a period of 90 min. During the addition period the reaction temperature was maintained at −5° C. The ³¹P NMR analysis exhibited transformation to the corresponding dichloridite 2c in 82% selectivity, a 14% drop in selectivity compared to example 10.

### Example 12

Synthesis of mixed phosphorochloridite 1d and phosphorodichloridite 2b. This example shows that a mixed chloridite (ABPCl type) derived from aromatic alcohols (ArOH) with little steric hindrance can be produced in high selectivity reaching a final chloridite concentration of 0.167 mol/l.

In a temperature controlled 1 L baffled flask equipped with an overhead stirrer charged with 60 ml of 1.0 molar PCl₃ in toluene and 0.6 ml 1.0 molar triethylamine in toluene. Under vigorous stirring a solution of 59 ml 1.0 molar triethylamine in toluene and a solution of 59 ml 1.0 molar 2,4-xylenol in toluene were added separately and concurrently via two peristaltic pumps at 1.5 ml/min. During the addition period the reaction temperature was maintained at −10° C. The ³¹P NMR analysis exhibited clean transformation to the corresponding dichloridite 2b in 96% selectivity. Then 59.0 ml of each 1.0 molar triethylamine solution in toluene and 1.0 molar o-ethylphenol solution in toluene where added separately and concurrently via two peristaltic pumps at 1.5 ml/min. The ³¹P NMR analysis exhibited clean transformation to the corresponding mixed chloridite 1d (δ 162.5) in 95% overall selectivity.

### Example 13

Synthesis of mixed phosphorochloridite 1d and phosphorodichloridite 2c. This example shows that a mixed chloridite (ABPCl type) derived from aromatic alcohols with little steric hindrance can be produced in high selectivity reaching a final chloridite concentration of 0.333 mol/1.

In a temperature controlled 1 L baffled flask equipped with an overhead stirrer charged with 200 ml of 1.0 molar PCl₃ in toluene and 2.0 ml 2.0 molar triethylamine in toluene a solution of 98 ml 2.0 molar triethylamine in toluene and under vigorous stirring a solution of 98 ml 2.0 molar o-ethylphenol in toluene were added separately and concurrently via two peristaltic pumps at 2.0 ml/min. During the addition period the reaction temperature was maintained at −10° C. The ³¹P NMR analysis showed clean transformation to the corresponding dichloridite 2c in 95% selectivity. Then 98 ml of each 2.0 molar triethylamine solution in toluene and 2.0 molar 2,4-xylenol solution in toluene where added separately and concurrently via two peristaltic pumps at 2 ml/min. The ³¹P NMR analysis exhibited clean transformation to the corresponding mixed chloridite 1d in 96% overall selectivity.

### Example 14

Synthesis of a mixed phosphorochloridite 1 g and phosphorodichloridite 2d. This example shows that a mixed chloridite (ABPCl type) derived from aromatic alcohols with little steric hindrance can be produced in high selectivity reaching a final chloridite concentration of 0.333 mol/l.

A temperature controlled 1 L baffled glass reactor with overhead stirrer was charged with 200 ml of 1.0 molar PCl₃ in toluene and 2 ml 2.0 molar triethylamine in toluene. Under vigorous stirring a solution of 100 ml of 2.0 molar triethylamine in toluene and 100 ml of 2.0 molar thymol in toluene were added separately and concurrently via two peristaltic pumps over a period of 50 min. During the addition period, the reaction temperature was maintained at −10° C. The ³¹P NMR analysis showed clean transformation to the corresponding dichloridite 2d (δ 181.2) in 95% selectivity. Another 100 ml of each 2.0 molar triethylamine solution in toluene and 100 ml 2.0 molar 2,4-xylenol solution in toluene were added separately and concurrently via a dual syringe pump over a period of 50 min. The 31 P NMR analysis showed clean transformation to the corresponding chloridite 1 g (δ 159.9) in 96% overall selectivity.

### Example 15

Synthesis of phosphorochloridite 1e and phosphorodichloridite 2e. This example shows that aliphatic phosphorochloridites and phosphorodichloridites can be produced in good selectivity.

A temperature controlled 300 ml baffled round bottom flask was charged with a solution of 25 ml 2.0 molar PCl₃ in toluene. Under vigorous stirring a solution of 25 ml 2.0 molar triethylamine in toluene and a solution of 25 ml 2.0 molar ethylalcohol in toluene were added separately and concurrently via a dual syringe pump over a period of 100 min. During the addition period the reaction temperature was maintained at −10° C. The ³¹P NMR analysis exhibited transformation to the corresponding dichloridite 2e in 94% selectivity. Another 25 ml of each 2.0 molar triethylamine solution in toluene and 2.0 molar ethylalcohol solution in toluene were added separately and concurrently via dual syringe pump over a period of 100 min. The ³¹P NMR analysis exhibited transformation to the corresponding chloridite 1e in 70% overall selectivity. Another 4.7 ml of each 2.0 molar triethylamine solution in toluene and 2.0 molar ethylalcohol solution in toluene were added separately and concurrently via a dual syringe pump. The final product distribution was 82% phosphorochloridite 1e and 18% triethylphosphite. No Ethylchloride was formed.

### Example 16

Synthesis of a phosphorochloridite 1f and phosphorodichloridite 2f. This example shows that a phosphorochloridite and phosphorodichloridite derived from an ortho unsubstituted phenol can be produced in good selectivity.

A temperature controlled 300 ml baffled round bottom flask was charged with 25 ml of 2.0 molar PCl₃ in toluene. Under vigorous stirring a solution of 25 ml 2.0 molar triethylamine in toluene and a solution of 25 ml 2.0 molar phenol in toluene were added separately and concurrently via a dual syringe pump over a period of 100 min. During the addition period the reaction temperature was maintained at −10° C. The ³¹P NMR analysis exhibited transformation to the dichloridite 2f in 92% selectivity. A second addition of 25 ml of each 2.0 molar triethylamine solution in toluene and 2.0 molar phenol solution in toluene were added separately and concurrently via a dual syringe pump over a period of 100 min. The ³¹P NMR analysis exhibited transformation to the corresponding chloridite 1f in 80% overall selectivity.

### Examples 17-32

Synthesis of mixed phosphites. These examples show the selective synthesis of mixed aromatic and aliphatic phosphites from phosphorochloridites 1a, 1c, 1d and 1e synthesized as described in examples 7, 10, 13 and 15.

To a 1 g aliquot of the corresponding crude phosphorochloridite and triethylammoniumchloride suspension in toluene as prepared in examples 7, 10, 13 and 15 about 1.2 equiv. of 2.0 molar NEt₃ in toluene were added. The mixture was stirred at 5° C. and 1.0 equiv. of the respective alcohol or 0.5 equiv. of the respective diol were added. Of this product suspension 0.4 ml of the reaction volume were combined with 0.8 ml 0.1 molar triphenylphosphineoxide in C₆D₆ and the mixture was analyzed by ³¹P NMR. Results are given in Table 3. All NMR chemical shifts are given in ppm in reference to triphenylphosphineoxide (δ 25.6).

TABLE 3

| | chloridite purity | | overall yield |
|---|---|---|---|
| | chloridite | | target phosphite |
| Example | ³¹P NMR δ | alcohol | ³¹P NMR δ |
| 17 | 94% | m-Cresol | 94% |
| | 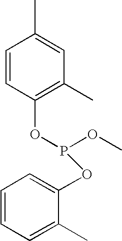 | | 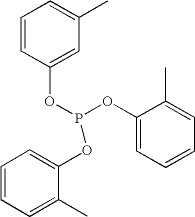 |
| | 161.9 | | 128.6 |
| 18 | 94% | iso-Propanol | 94% |
| | 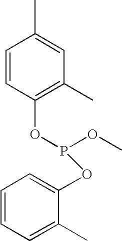 | | 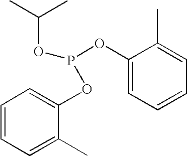 |
| | 161.9 | | 131.2 |
| 19 | 94% | 2,4-Xylenol | 94% |
| | 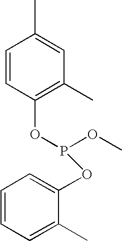 | | 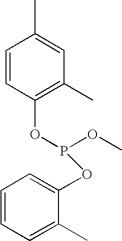 |
| | 161.9 | | 131.1 |
| 20 | 94% | Phenol | 94% |
| | 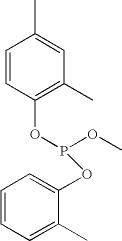 | | 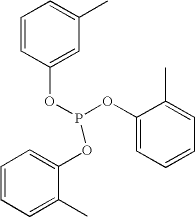 |
| | 161.9 | | 131.5 |
| 21 | 92% | m-Cresol | 92% |
| | 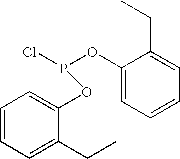 | | 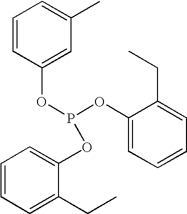 |
| | 161.5 | | 127.8 |
| 22 | 92% | iso-Propanol | 92% |
| | 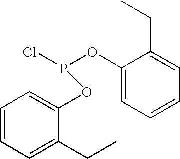 | | 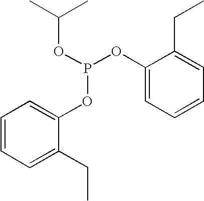 |
| | 161.5 | | 130.9 |
| 23 | 92% | 2,4-Xylenol | 92% |
| | 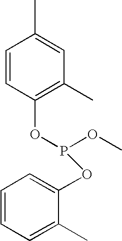 | | 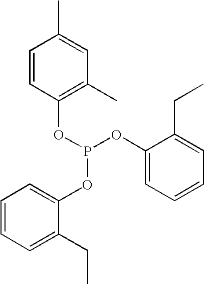 |
| | 161.5 | | 129.3 |
| 24 | 92% | Phenol | 92% |
| | 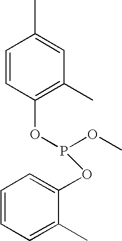 | | 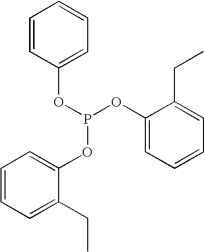 |
| | 161.5 | | 127.3 |
| 25 | 82% | m-Cresol | 82% |
| | 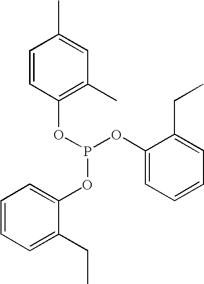 | | 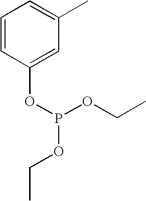 |
| | 167.4 | | 134.0 |
| 26 | 82% | iso-Propanol | 82% |
| | 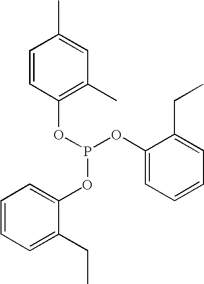 | | 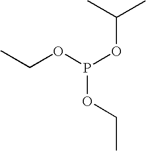 |
| | 167.4 | | 139.3 |
| 27 | 82% | 2,4-Xylenol | 82% |
| | 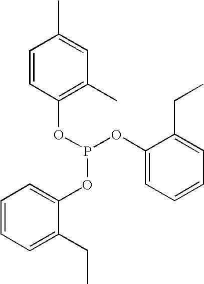 | | 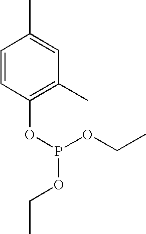 |
| | 167.4 | | 134.3 |
| 28 | 82% | Phenol | 82% |
| | 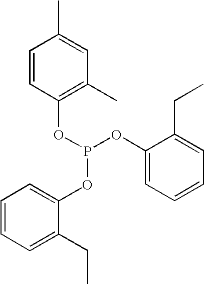 | | 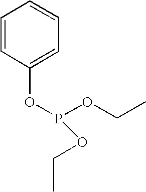 |
| | 167.4 | | 133.9 |
| 29 | 94% | m-Cresol | 94% |
| | 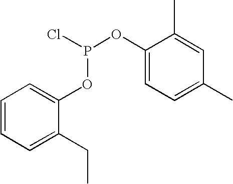 | | 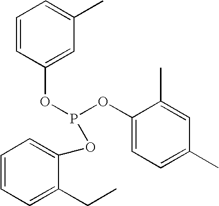 |
| | 162.5 | | 130.0 |
| 30 | 94% | iso-Propanol | 94% |
| | 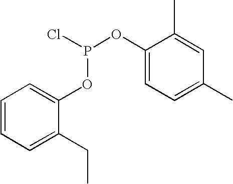 | | 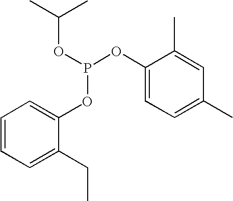 |
| | 162.5 | | 131.4 |
| 31 | 94% | 2,4-Xylenol | 94% |
| | 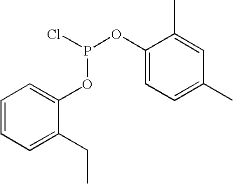 | | 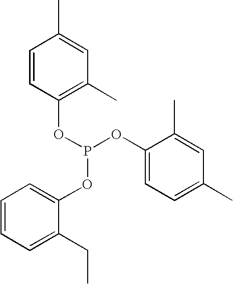 |
| | 162.5 | | 131.6 |
| 32 | 94% | Phenol | 94% |
| | 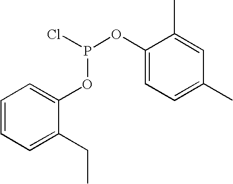 | | 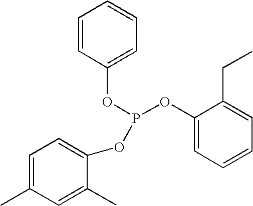 |
| | 162.5 | | 131.1 |
| 33 | 94% | Bisnaphthol | 90% |
| | 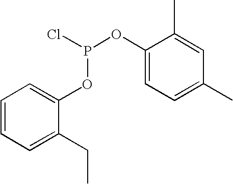 | | 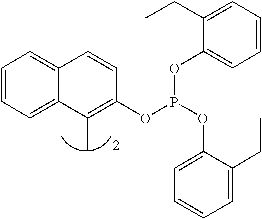 |
| | 162.5 | | 130.0 |
| 34 | 92% | Bisnaphthol | 88% |
| | 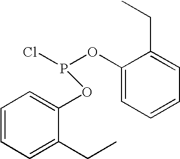 | | 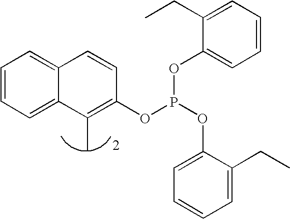 |
| | 161.5 | | 129.6 |
| 35 | 94% | Bisnaphthol | 90% |
| | 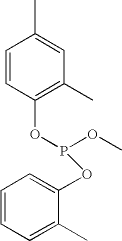 | | 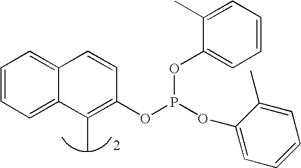 |
| | 161.9 | | 129.0 |

### COMPARATIVE EXAMPLES

### Comparative Example A

Synthesis of phosphorochloridite 1a and phosphorodichloridite 2a under the conditions described in where a mixture of amine and alcohol was added to the PCl₃ at 0.67 equiv/h

A temperature controlled 250 ml baffled flask was charged with 50 ml of 1.0 molar PCl₃ in toluene. Under vigorous stirring a mixture of 25 ml 2.0 molar triethylamine in toluene and 25 ml 2.0 molar o-cresol in toluene was added via a single syringe pump over a period of 90 min. During the addition period the reaction temperature was maintained at −5° C. The ³¹P NMR analysis showed transformation to the corresponding dichloridite 2a in only 16% selectivity. The distribution was PCl₃ 56%; dichloridite 7%; chloridite 9%; triarylphosphite 28%. Another mixture of 25 ml 2.0 molar triethylamine in toluene and 25 ml 2.0 molar o-cresol in toluene was added under vigorous stirring via a single syringe pump over a period of 90 min. During the addition period the reaction temperature was maintained at −5° C. The ³¹P NMR analysis showed transformation to the corresponding chloridite 1a in only 14% overall selectivity. The distribution was PCl₃ 21%; dichloridite 7%; chloridite 14%; triarylphosphite 58%.

### Comparative Example B

Synthesis of a phosphorochloridite 1a and phosphorodichloridite 2a under the conditions described in where a mixture of amine and alcohol are added to the PCl₃ at 0.3 equiv/h.

A temperature controlled 300 ml baffled round bottom flask was charged with 25 ml of 2.0 molar PCl₃ in toluene. Under vigorous stirring a mixture of 25 ml 2.0 molar triethylamine in toluene and 25 ml 2.0 molar o-cresol in toluene was added via a single syringe pump over a period of 200 min. During the addition period the reaction temperature was maintained at −5° C. The ³¹P NMR analysis showed transformation to the corresponding dichloridite 2a in only 14% selectivity. The distribution was PCl₃ 57%; dichloridite 6%; chloridite 10%; and triarylphosphite 28%. Another mixture of 25 ml 2.0 molar triethylamine in toluene and 25 ml 2.0 molar o-cresol in toluene was added under vigorous stirring via a single syringe pump over a period of 200 min. During the addition the reaction temperature was maintained at −5° C. The ³¹P NMR analysis showed transformation to the corresponding chloridite 1a in only 17% overall selectivity. The distribution was PCl₃ 18%; dichloridite 9%; chloridite 17%; and triarylphosphite 56%.

### Comparative Example C

Synthesis of phosphorochloridite 1a and phosphorodichloridite 2a where two equivalents of the amine were added to a mixture of one equivalent of PCl₃ and two equivalents of alcohol.

A temperature controlled 300 ml baffled round bottom flask was charged with a mixture of 50 ml of 1.0 molar PCl₃ and 50 ml of 2.0 molar o-cresol both in toluene. A solution of 25 ml 2.0 molar triethylamine in toluene was added under vigorous stirring via a single syringe pump over a period of 100 min. During the addition period the reaction temperature was maintained at −5° C. The ³¹P NMR analysis showed transformation to the corresponding dichloridite 2a in only 51% selectivity. The distribution was PCl₃ 10%; dichloridite 46%; chloridite 29%; triarylphosphite 15%. Another 25 ml 2.0 molar triethylamine in toluene were added under vigorous stirring via a single syringe pump over a period of 100 min. During the addition period the reaction temperature was maintained −5° C. The ³¹P NMR analysis showed transformation to the corresponding chloridite 1a in only 68% overall selectivity. The distribution was dichloridite 14%, chloridite 68%, and triarylphosphite 18%.

TABLE 4
Comparison of yields for 1a and 2a for concurrent but
separate addition procedure as given in example 2 with
other procedures as given in examples A-C.

| | | Equivalents | | | | |
|---|---|---|---|---|---|---|
| | Temp | ArOH and | | | % | % |
| Example | (° C.) | NEt₃ added | % 1a | % 2a | PCl₃ | (o-tolyl-O)₃P |
| 2 | −5 | 1.0 | 3 | 97 | 0 | 0 |
| | | 2.0 | 91 | 4 | 0 | 5 |
| A | −5 | 1.0 | 9 | 7 | 56 | 28 |
| | | 2.0 | 14 | 7 | 21 | 58 |
| B | −5 | 1.0 | 10 | 6 | 57 | 27 |
| | | 2.0 | 17 | 9 | 18 | 56 |
| C | −5 | 1.0 | 29 | 46 | 10 | 15 |
| | | 2.0 | 68 | 14 | 0 | 18 |

Comparative Example D

Synthesis of phosphorochloridite 1e and phosphorodichloridite 2e under the conditions described where two equivalents of the amine were added to a mixture of one equivalent of PCl₃ and two equivalents of ethylalcohol

A temperature controlled 300 ml baffled round bottom flask was charged with a solution of 25 ml 2.0 molar PCl₃ in toluene and mixed with a −20° C. cold solution of 50 ml 2.0 molar ethylalcohol in toluene. Under vigorous stirring a solution of 25 ml 2.0 molar triethylamine in toluene was added via a single syringe pump over a period of 100 min. During the addition period the reaction temperature was maintained at −10° C. The ³¹P NMR analysis exhibited transformation to the corresponding dichloridite 2e in only 48% selectivity. The distribution was dichloridite 48%, chloridite 24%, and 28% (EtO)₂PO(H) (δ 64.1) as a byproduct of ethylchloride formation. Another solution of 25 ml 2.0 molar triethylamine in toluene was added via a single syringe pump over a period of 100 min. During the addition period the reaction temperature was maintained at −10° C. The ³¹P NMR analysis exhibited a transformation to the corresponding chloridite 1e in 25% overall selectivity. The distribution was dichloridite 46%, chloridite 25%, and 29% (EtO)₂PO(H) as a byproduct of ethylchloride formation.

Comparative Example E

Synthesis of phosphorochloridite 1e and phosphorodichloridite 2e where a mixture of two equivalents each of amine and alcohol were added to one equivalent of PCl₃

A temperature controlled 300 ml baffled round bottom flask was charged with 25 ml of 2.0 molar PCl₃ in toluene. Under vigorous stirring a mixture of 25 ml 2.0 molar triethylamine in toluene and 25 ml 2.0 molar ethylalcohol in toluene was added via a single syringe pump over a period of 200 min. During the addition period the reaction temperature was maintained at −10° C. The ³¹P NMR analysis exhibited transformation to the corresponding dichloridite 2e in 26% selectivity. The distribution was PCl₃ 61%, dichloridite 10%, chloridite 13% and triethylphosphite 16%. A second mixture of 25 ml both 2.0 molar triethylamine in toluene and 2.0 molar ethylalcohol in toluene were added under vigorous stirring via a single syringe pump over a period of 200 min. During the addition period the reaction temperature was maintained at −10° C. The ³¹P NMR analysis exhibited transformation to the corresponding chloridite 1e in 31% overall selectivity. The distribution was PCl₃ 18%, dichloridite 15%, chloridite 31% and triethylphosphite 35%.

TABLE 5
Comparison of yields for 1e and 2e for concurrent but separate addition procedure
as given in example 15 with other procedures as given in examples D and E.

| | | Equivalents | | | | | |
|---|---|---|---|---|---|---|---|
| | Temp | ArOH and | | | % | % | % |
| Example | (° C.) | NEt₃ added | % 1a | % 2a | PCl₃ | (EtO)₂PO(H) | (EtO)₃P |
| 15 | −10 | 1.0 | 4 | 79 | 14 | 0 | 3 |
| | | 2.0 | 70 | 19 | 0 | 0 | 11 |
| | | 2.18 | 82 | 0 | 0 | 0 | 18 |
| D | −10 | 1.0 | 24 | 48 | 0 | 28 | 0 |
| | | 2.0 | 25 | 46 | 0 | 29 | 0 |
| E | −10 | 1.0 | 13 | 10 | 61 | 0 | 16 |
| | | 2.0 | 31 | 15 | 18 | 0 | 35 |

What is claimed is:

1. A process for the selective production of R¹OPX₂; (R¹O)(R² O)PX and (R¹O)(R² O)P(O R³) wherein X=Cl, Br, I, and R¹, R², and R³ are the same or different C1 to C18 aryl or alkyl radicals, comprising:
(i) contacting PX₃ in the presence of an aprotic solvent with an alcohol R¹OH and a triorganoamine, wherein the amine and the alcohol are added either (a) separately and concurrently, or as (b) alternating equimolar portions of amine and alcohol, to produce R¹OPX₂;
(ii) optionally contacting the reaction product of (i) with an alcohol R²OH and a triorganoamine, wherein the amine and the alcohol are added either (a) separately and concurrently, or as (b) alternating equimolar portions of amine and alcohol, to produce (R¹O)(R²O)PX;
(iii) optionally contacting the reaction product of (i or ii) with an alcohol R³OH and a triorganoamine, to produce (R¹O)(R²O)P(OR³).

2. A process according to claim 1 wherein the triorganoamine is a trialkylamine.

3. A process according to claim 2 wherein the trialkylamine is trimethylamine, dimethylethylamine, triethylamine, diethylmethylamine, triethylamine, dimethylpropylamine and dimethylisopropylamine.

4. A method according to claim 1 wherein the triorganoamine is a substituted or unsubstituted amine or substituted or unsubstituted heteroaromatic amine.

5. A method according to claim 1 wherein the alcohol is a polyol.

6. A method according to claim 1 wherein the alcohol is a diol.
